(19) United States
(12) Patent Application Publication
(10) Pub. No.: US 2025/0155018 A1
(43) Pub. Date: May 15, 2025

(54) Bottom-bracket Transmission for a Micromobility Vehicle

(71) Applicant: ZF Friedrichshafen AG, Friedrichshafen (DE)

(72) Inventors: Michel Wiemer, Weingarten (DE); Thomas Riedisser, Sigmarszell (DE); Hagen Doepfert, Lindau (DE); Uwe Schraff, Markdorf (DE); Peter Ziemer, Bad Woerishofen (DE); Leschek Debernitz, Eriskirch (DE); Christoph Margraf, Markdorf (DE); Ulrich Doerr, Konstanz (DE); Markus Strobel, Ravensburg (DE); Uwe Griesmeier, Markdorf (DE)

(21) Appl. No.: 18/838,349

(22) PCT Filed: Feb. 10, 2023
(86) PCT No.: PCT/EP2023/053342

§ 371 Date: Aug. 14, 2024

(30) Foreign Application Priority Data
Feb. 14, 2022 (DE) 10 2022 201 482.0

(51) Int. Cl. F16H 63/08; F16H 59/68; F16H 61/32; F16H 63/30; F16H 63/34

(52) U.S. Cl. CPC F16H 63/08; F16H 59/68; F16H 61/32; F16H 63/304; F16H 63/3425; F16H 63/3466

(57) ABSTRACT

A bottom bracket gearbox for a micromobility vehicle (1) includes at least one shift element. Each shift element includes a shift ring (3) with an outer toothing (4). The shift ring assigned a shift pawl (5) for locking or releasing the shift ring (3) of the shift element. The shift ring being assigned to a gearbox component. At least one rotatably mounted shift drum (7) for actuating the assigned shift pawl (5) is axially parallel to a central axis of rotation of the gearbox (6). A shift actuator (8) is arranged in the interior of the shift drum (7), which is formed, at least partially or in sections, as a hollow shaft.

### CROSS-REFERENCE TO RELATED APPLICATIONS

The present application is related and has right of priority to German Patent Application No. DE 102022201482.0 filed on Feb. 14, 2022, and is a U.S. national phase of PCT/EP2023/053342 filed on Feb. 10, 2023, both of which are incorporated by reference in their entireties for all purposes.

### TECHNICAL FIELD

The present invention relates generally to a bottom bracket gearbox in a planetary gear set design for a micromobility vehicle. The invention further relates generally to a micromobility vehicle having the bottom bracket gearbox.

### BACKGROUND

For example, the publication DE 10 2019 220 044 A1 describes a bottom bracket gearbox in a planetary gear set design for a bicycle or a pedelec, which bottom bracket gearbox has an arrangement for actuating at least one brake shift element and multiple planetary gear sets for implementing various gear stages. The bottom bracket gearbox is assigned multiple brake shift elements, each of which has a brake ring that is assigned to a gearbox component and can be locked or released using a brake pawl in order to shift a predetermined, assigned gear stage. Each brake pawl is actuated by a rotatably mounted shift drum, which is arranged approximately axially parallel to a central axis of rotation of the bottom bracket gearbox. A Bowden cable is provided for rotationally actuating the shift drum. For this purpose, a rotationally fixed pin or the like is secured on the shift drum outside the housing, one end of the Bowden cable being connected to the pin, while the other end of the Bowden cable is arranged, for example, on a handlebar of the bicycle or pedelec in order to be actuated by the operator, so that the shift drum can be actuated via the Bowden cable in order to be able to shift a desired gear stage.

### BRIEF SUMMARY

Example aspects of the present invention provide a bottom bracket gearbox and a micromobility vehicle having the bottom bracket gearbox, in which a particularly simple and installation space-neutral actuation of the shift drum is provided.

Example aspects of the invention relate to a bottom bracket gearbox in a planetary gear set design for a micromobility vehicle, which bottom bracket gearbox has at least one shift element for shifting a gear stage, each shift element having a shift ring with an outer toothing or the like, the shift ring being assigned a shift pawl for locking and releasing the shift ring of the shift element, the shift ring being assigned to a gearbox component, and at least one rotatably mounted shift drum for actuating the assigned shift pawl is axially parallel to a central axis of rotation of the gearbox. In order to provide the actuation of the shift drum in a structurally simple and installation-space-favorable manner, a shift actuator for actuating the shift drum is arranged in the interior of the shift drum, which is formed, at least partially or in sections, as a hollow shaft.

In this way, the actuation is integrated in the form of a shift actuator into the shift drum in an installation space-neutral manner in that the shift drum is hollow, at least partially or in sections, so that the actuator unit is at least partly arranged radially inside, or radially nested, in the shift drum, as a result of which the axial installation space required in the gearbox housing is considerably reduced and, therefore, the specified axial width of the gearbox housing between the pedal cranks of the micromobility vehicle is not exceeded.

A micromobility vehicle is understood to be a bicycle which can be operated using muscle power and/or using an electric drive motor, the micromobility vehicle having a bottom bracket in any case. Micromobility vehicles include, for example, bicycles, pedelecs, S-pedelecs, cargo bikes, velomobiles, e-bikes.

A structurally simple implementation of the torque transmission between the preferably electro-mechanical shift actuator and the shift drum can be carried out, within the framework of example aspects of the invention, via an input pinion of the shift actuator, which input pinion is in engagement with inner toothing, or the like, as an entrainment profile in the interior of the shift drum. In addition to the structurally simple design, the torque transmission in the inner region of the shift drum results in a highly compact design overall in the gearbox housing.

In order to achieve an optimal actuation of the shift drum by the electro-mechanical shift actuator in the bottom bracket gearbox according to example aspects of the invention, it is provided within the framework of example aspects of the invention that the electro-mechanical shift actuator has, in addition to an electric motor or servomotor, or the like, an integrated reduction gear. Using the reduction gear, the necessary rotation of the shift drum for actuating the shift pawls can be achieved by the electro-mechanical shift actuator.

Due to the fact that the shift actuator and the shift drum are arranged coaxially in a practically radially nested manner, the advantage results that the shift drum can be accommodated in an installation space-saving manner in the gearbox housing with the shift actuator practically axially parallel to the axis of rotation of the gearbox, so that the amount of axial installation space required can be reduced, e.g., to a minimum.

To provide structurally simple and installation space-favorable torque support between the shift actuator and the gearbox housing, it can be provided within the framework of example aspects of the invention that the shift actuator is retained in the shift drum and fastened to the gearbox housing via a support sleeve, or the like, for supporting torque.

Various arrangements are conceivable with respect to the structural design of the support sleeve that is used. In a particularly installation space-favorable and sufficiently stable example embodiment, the support sleeve has an approximately hollow cylindrical, or cylindrical, receiving region for accommodating the shift actuator. A first end of the receiving region, which is assigned to the input pinion of the shift actuator, has a through-opening, or hole, or the like, for the input pinion to axially pass through, and a second end of the receiving region has a fastening flange for connecting the support sleeve to the gearbox housing.

Consequently, the shift actuator, including a housing of the shift actuator, is accommodated in the support sleeve for supporting torque, such that the rotating input pinion projects axially out of the support sleeve in order to be interlockingly connected to the entraining tooth system of the shift drum, as a result of which, in addition to the torque support, the torque transmission between the shift actuator and the shift drum is also ensured.

In order to detect a position or rotational angle at the shift drum in a installation space-neutral manner, it is provided within the framework of example aspects of the invention that an angle-of-rotation measuring transmitter, or the like, for detecting the rotational angle position is arranged on an end face of the shift drum in a radially internal region of the shift drum. For example, the angle-of-rotation measuring transmitter can be fastened on the shift drum via a press-fit connection, by adhesive, such as glue, or the like. To this end, the shift drum is also hollow in this region, in order to arrange the components of the carrier in a radially nested manner.

Preferably, an angle-of-rotation measuring receiver, which faces the angle-of-rotation measuring transmitter of the shift drum, is arranged on the gearbox housing side. Due to the arrangement of the angle-of-rotation measuring receiver so as to be fixed to the housing, the signal transmission of the angle-of-rotation measuring receiver in the bottom bracket gearbox according to example aspects of the invention is considerably simplified.

As shift elements, brake shift elements are preferably provided in the bottom bracket gearbox. Such a brake shift element has a brake ring which is lockable via a brake pawl in only one direction of rotation, the brake pawl being actuatable via the shift drum. Due to the locking of a brake ring which is assigned to a gearbox component, the assigned gear stage is shifted in the bottom bracket gearbox.

A further example aspect of the present invention is directed to a micromobility vehicle having the above-described bottom bracket gearbox, as a result of which the above-described advantages and further advantages result.

### BRIEF DESCRIPTION OF THE DRAWINGS

Example aspects of the present invention are explained in greater detail in the following with reference to the drawings, wherein:

FIG. 1 shows a sectional view of one embodiment variant of a bottom bracket gearbox according to example aspects of the invention for a micromobility vehicle;

FIG. 2 shows a sectional view of the bottom bracket gearbox along the section line A-A shown in FIG. 1;

FIG. 3 shows a schematic three-dimensional view of a shift drum of the bottom bracket gearbox;

FIG. 4 shows a three-dimensional longitudinal section of the shift drum; and

FIG. 5 shows a schematic single-part view of a support sleeve for a shift actuator of the bottom bracket gearbox.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

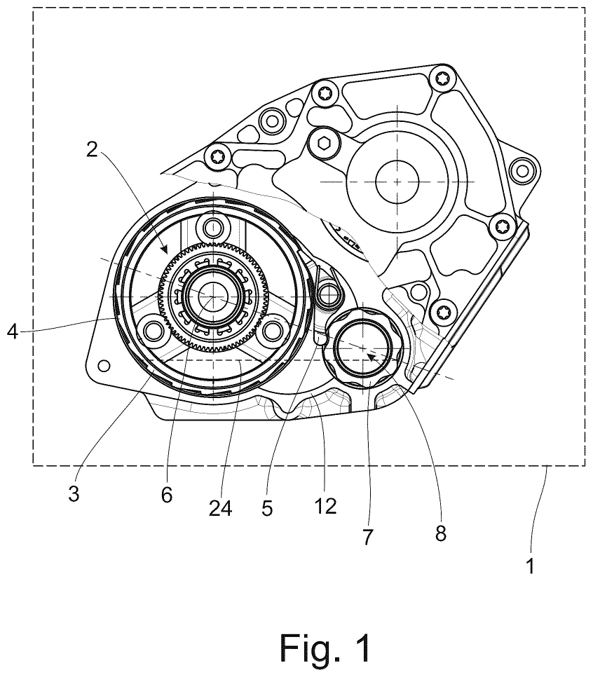

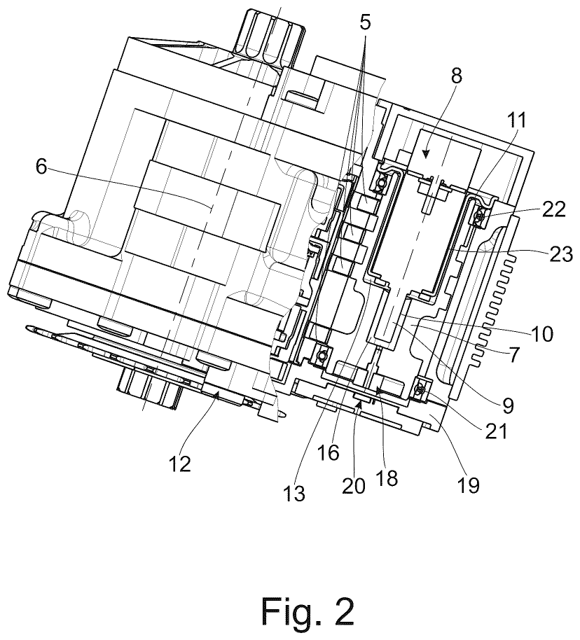

FIGS. 1 and 2 show various views of a bottom bracket gearbox according to example aspects of the invention in a planetary gear set design by way of example on the basis of a micromobility vehicle 1.

The bottom bracket gearbox has multiple planetary gear sets 2, which are coaxial with a central axis of rotation of the gearbox, in a gearbox housing, or bottom bracket housing 12, for implementing various gear stages using multiple shift elements, which are in the form of brake shift elements by way of example. Each shift element, or brake shift element, has a shift ring, or brake ring 3, which has an outer toothing 4, the shift ring being assigned a shift pawl, or brake pawl 5, for locking or releasing the brake ring 3 of the brake shift element, the brake ring being assigned to a gearbox component of the planetary gear sets 2.

The brake ring 3 is coaxial with the axis of rotation of the gearbox 6 of the planetary gear sets 2. To actuate multiple brake pawls 5, a rotatably mounted shift drum 7 is provided, which is axially parallel to the central axis of rotation of the gearbox 6. The shift drum 7 is assigned to an oil sump 24 of the bottom bracket gearbox for better oil supply. Due to the fact that the shift drum 7 plunges, at least partially or in sections, into the oil located in the oil sump 24, the shift drum 7 and the surrounding components are supplied with oil, which is indicated, in particular, in FIG. 1.

In order to achieve an actuation of the shift drum 7, e.g., that is as installation space-neutral as possible, an electro-mechanical shift actuator 8 is arranged in the interior of the shift drum 7 which is in the form, at least partially or in sections, of a hollow shaft. Consequently, a radially nested design of the shift drum 7 and of the electro-mechanical shift actuator 8 is provided.

Due to the fact that the shift drum 7 is hollow, partially or in sections, on the inside, the shift actuator 8, which includes an electric servomotor and a reduction gear, can be accommodated as a unit in a nested manner radially inside the shift drum 7 in order to minimize the axial width necessary between the pedal cranks of the bottom bracket gearbox.

In order to transmit torque, an input pinion 9 of the shift actuator 8 is in engagement with inner toothing 10 as an entrainment profile in the inner region of the shift drum 7. The shift actuator 8 and the shift drum 7 are coaxial.

In order to support torque, the shift actuator 8 is retained in the shift drum 7 and fastened to a gearbox housing, or bottom bracket housing 12, of the bottom bracket gearbox via a support sleeve 11.

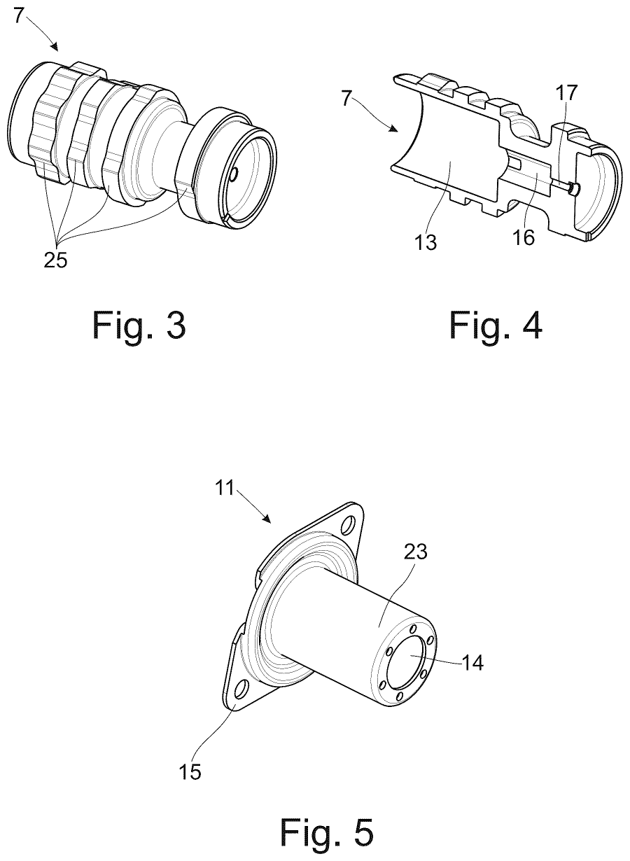

From the individual-part view of the shift drum shown in FIGS. 3 and 4, and of the support sleeve 11 shown in FIG. 5, it becomes clear that the support sleeve 11 has an approximately hollow cylindrical receiving region 23 for accommodating the shift actuator 8. The receiving region 23 is assigned to a first receiving chamber 13 in the interior of the shift drum 7. The receiving region 23 has, at a first end assigned to the input pinion 9 of the shift actuator 8, a through-opening 14 for the input pinion 9 to axially pass through, while a second end of the receiving region 23 has a fastening flange 15 for fastening the support sleeve 11 on the gearbox housing 12. The input pinion 9 is assigned to a second receiving chamber 16 in the interior of the shift drum 7, the second receiving chamber adjoining the first receiving chamber 13 when viewed axially, and the inner toothing 10, as an entrainment profile of the shift drum 7, is assigned to the second receiving chamber 16, the input pinion 9 being interlockingly connected to the inner toothing.

A third receiving chamber 17 adjoins the second receiving chamber 16 in the interior of the shift drum 7 when viewed axially. An angle-of-rotation measuring transmitter 18 for position detection on the shift drum 7 is assigned to the third receiving chamber 17. The angle-of-rotation measuring transmitter 18 for detecting the position of the shift drum is fastened directly opposite the shift actuator 8 to the end face of the shift drum 7 via a press-fit connection or by adhesive, such as glue. A corresponding angle-of-rotation measuring receiver 20 is secured to the housing directly opposite the angle-of-rotation measuring transmitter 18 in the region of a housing cover 19 of the gearbox housing 12 in order to sense the angular position of the shift drum 7.

The angle-of-rotation measuring receiver 20 arranged on the gearbox housing side is preferably fastened on the outside on a thin wall of the housing cover 19. The housing cover 19 is preferably made of aluminum or plastic, so that the transducer signal can be detected through the non-ferromagnetic wall directly by the angle-of-rotation measuring receiver 20 arranged in the dry region.

The electric servomotor of the shift actuator 8 is preferably a BLDC motor having Hall sensing. The closed-loop control is carried out via a 3-stage cascaded PI controller. The position controller uses both the absolute angle information from the shift drum rotational angle detection and the rotor position information from the internally installed Hall sensors of the shift actuator 8 and, as a result, achieves increased accuracy.

As is apparent, in particular, from FIGS. 3 and 4, multiple shift gates 25 are provided on the outer circumference of the shift drum 7. The shift gates 25 are configured differently with respect to their protrusions and depressions, or peaks and valleys, over the peripheral region. Each shift gate 25 of the shift drum 7 is assigned to a brake pawl 5 for actuating the respective shift gate, or for shifting a predetermined gear stage.

The shift drum 7 is radially mounted in the gearbox housing 12 via a first grooved ball bearing 21 and a second grooved ball bearing 22. In particular from FIG. 2 it is apparent that the second grooved ball bearing 22, which is assigned to the shift actuator 8, has a press fit with respect to the shift drum 7 and is used not only for the radial guidance but simultaneously also for the axial guidance of the shift drum 7. This second grooved ball bearing 22 is connected via the inner ring of the second grooved ball bearing 22 to the shift drum 7 in a friction-locking manner via the press-fit and guided axially via the outer ring of the second grooved ball bearing 22 between the gearbox housing 12 and the support sleeve 11. This results in a particularly short tolerance chain in the radial direction and, simultaneously, in the axial direction at the air gap between the angle-of-rotation measuring transmitter 18 on the shift drum 7 and the angle-of-rotation measuring receiver 20 on the housing cover 19, as a result of which the precision of the gear shift is increased.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

1 micromobility vehicle
2 planetary gear set
3 shift ring or brake ring
4 outer toothing
5 shift pawl or brake pawl
6 central axis of rotation of the gearbox
7 shift drum
8 shift actuator
9 input pinion of the shift actuator
10 inner toothing as entrainment profile of the shift drum
11 support sleeve
12 gearbox housing or bottom bracket housing
13 first receiving chamber in the interior of the shift drum
14 through-opening in the receiving region of the support sleeve
15 fastening flange of the support sleeve
16 second receiving chamber in the interior of the shift drum
17 third receiving chamber in the interior of the shift drum
18 angle-of-rotation measuring transmitter
19 housing cover
20 angle-of-rotation measuring receiver
21 first grooved ball bearing
22 second grooved ball bearing
23 receiving region of the support sleeve
24 oil sump in the gearbox housing
25 shift gate

1-10: (canceled)

11. A bottom bracket gearbox for a micromobility vehicle (1), comprising:
a shift element comprising a shift ring (3) with an outer toothing (4), the shift ring (3) engageable with a shift pawl (5) for locking or releasing the shift ring (3), the shift ring (3) assigned to a gearbox component;
a rotatably mounted shift drum (7) for actuating the shift pawl (5), the shift drum (7) arranged axially parallel to a central rotation axis of the gearbox (6), the shift drum (7) at least partially formed as a hollow shaft; and
a shift actuator (8) arranged in an interior of the shift drum (7).

12. The bottom bracket gearbox of claim 11, wherein the shift actuator (8) comprises an electro-mechanical shift actuator (8) that is engaged via an input pinion (9) with inner toothing (10) as an entrainment profile in the interior of the shift drum (7).

13. The bottom bracket gearbox of claim 11, wherein the shift actuator (8) comprises an electric motor and an integrated reduction gear.

14. The bottom bracket gearbox of claim 11, wherein the shift actuator (8) and the shift drum (7) are arranged coaxially.

15. The bottom bracket gearbox of claim 11, wherein the shift actuator (8) is retained in the shift drum (7) and fastened to a gearbox housing (12) via a support sleeve (11) for supporting torque.

16. The bottom bracket gearbox of claim 15, wherein:
the support sleeve (11) defines an approximately hollow cylindrical receiving region (23) for accommodating the shift actuator (8);
a first end of the receiving region (23), which is assigned to an input pinion (9), defines a through-opening (14) for the input pinion (9) to axially pass through; and
a second end of the receiving region (23) comprises a fastening flange (15) for connecting the support sleeve (11) to the gearbox housing (12).

17. The bottom bracket gearbox of claim 11, further comprising an angle-of-rotation measuring transmitter (18) for position detection arranged on an end face of the shift drum (7) in a radially internal region.

18. The bottom bracket gearbox of claim 17, further comprising an angle-of-rotation measuring receiver (20) facing the angle-of-rotation measuring transmitter (18) on the shift drum (7) and arranged on a gearbox housing side.

19. The bottom bracket gearbox of claim 11, wherein the shift element comprises a brake shift element with a brake ring (3) lockable via a brake pawl (5) in only one direction of rotation.

20. A micromobility vehicle (1), comprising the bottom bracket gearbox of claim 11.
